(19) United States
(12) Patent Application Publication
(10) Pub. No.: US 2025/0048352 A1
(43) Pub. Date: Feb. 6, 2025

(54) NETWORK SCHEDULING DEVICE AND METHOD

(71) Applicants: Samsung Electronics Co., Ltd., Suwon-si (KR); UIF (University Industry Foundation), Yonsei University, Seoul (KR)

(72) Inventors: Ilsong SIM, Suwon-si (KR); Gun KO, Gunpo-si (KR); Won Woo RO, Seoul (KR); Sangeon KIM, Suwon-si (KR); Seunghyun MIN, Suwon-si (KR)

(21) Appl. No.: 18/920,417

(22) Filed: Oct. 18, 2024

Related U.S. Application Data
(63) Continuation of application No. PCT/KR2023/001386, filed on Jan. 31, 2023.

(30) Foreign Application Priority Data
Apr. 21, 2022 (KR) 10-2022-0049723
May 30, 2022 (KR) 10-2022-0066233

(51) Int. Cl. H04W 72/1263; H04W 72/543

(52) U.S. Cl. CPC H04W 72/1263; H04W 72/543

(57) ABSTRACT

A network scheduling device and method are disclosed. The scheduling method comprises: determining whether a set condition for a transmission time interval (TTI) is satisfied, and, if the set condition is satisfied, storing in a memory, at each TTI until the set TTI elapses, a data array comprising the network state of the current TTI, the scheduler type selected at the network state of the current TTI, the network state of the next TTI, and the actual compensation value for the network state of the current TTI, and updating the parameters of the first neural network based on at least one of the data arrays stored in the memory, and, if the set condition is not satisfied, inputting the network state of the current TTI to the first neural network and selecting a scheduler using the output of the first neural network based on the input network state of the current TTI.

### CROSS-REFERENCE TO RELATED APPLICATIONS

This application is a continuation of International Application No. PCT/KR2023/001386 designating the United States, filed on Jan. 31, 2023, in the Korean Intellectual Property Receiving Office and claiming priority to Korean Patent Application Nos. 10-2022-0049723, filed on Apr. 21, 2022, and 10-2022-0066233, filed on May 30, 2022, in the Korean Intellectual Property Office, the disclosures of each of which are incorporated by reference herein in their entireties.

### BACKGROUND

### Field

The disclosure relates to a network scheduling technique.

### Description of Related Art

With the change in the form of mostly consumed content from text and photo to video and audio, the complexity of existing data transmission techniques in networks increases, making it difficult to improve the quality of service (QOS) of the networks. Therefore, the need for a technique for maximizing/improving user equipment (UE) scheduling performance and quality of communication service in data transmission is increasing at base stations.

A UE scheduler of a base station attempts scheduling by assigning time and frequency resources to a specific number of UEs included in a cell. The resources are divided by a predetermined unit, called a resource block (RB) which is a minimum unit of data used in the scheduling process. The base station performs scheduling to assign RBs while maximizing the throughput and ensuring fairness among UEs.

### SUMMARY

A scheduling device according to an example embodiment may include: at least one processor, comprising processing circuitry, and a memory configured to store instructions configured to be executed by at least one processor, wherein at least one processor, individually and/or collectively, may be configured to execute the instructions and to cause the device to: determine whether a set condition for a transmission time interval (TTI) is satisfied, store, in the memory at each TTI until a set TTI elapses, a data array including a network state of a current TTI, a scheduler type selected at the network state of the current TTI, a network state of a next TTI, and an actual compensation value for the network state of the current TTI, in response to the set condition being satisfied, update parameters of a first neural network based on at least one of data arrays stored in the memory, input the network state of the current TTI into the first neural network, in response to the set condition not being satisfied, and select a scheduler using an output from the first neural network based on the input network state of the current TTI.

A scheduling method according to an example embodiment may include: determining whether a set condition for a transmission time interval (TTI) is satisfied, storing, in a memory at each TTI until a set TTI elapses, a data array including a network state of a current TTI, a scheduler type selected at the network state of the current TTI, a network state of a next TTI, and an actual compensation value for the network state of the current TTI, in response to the set condition being satisfied, updating parameters of a first neural network based on at least one of data arrays stored in the memory, inputting the network state of the current TTI into the first neural network, in response to the set condition not being satisfied, and selecting a scheduler using an output from the first neural network based on the input network state of the current TTI.

### BRIEF DESCRIPTION OF DRAWINGS

The above and other aspects, features and advantages of certain embodiments of the present disclosure will be more apparent from the following detailed description, taken in conjunction with the accompanying drawings, in which:

FIG. 1 is a diagram illustrating example operations performed by a scheduling device according to various embodiments;

FIG. 2 is a diagram illustrating an example network state processing operation performed by a scheduling device according to various embodiments;

FIG. 3 is a diagram illustrating an example data array stored in a memory buffer of a scheduling device according to various embodiments;

FIG. 4 is a diagram illustrating an example method of updating parameters of a policy neural network according to various embodiments;

FIGS. 5 and 6 are flowcharts illustrating an example scheduling method according to various embodiments; and

FIG. 7 is a block diagram illustrating an example configuration of a scheduling device according to various embodiments.

### DETAILED DESCRIPTION

Hereinafter, various example embodiments will be described in greater detail with reference to the accompanying drawings. When describing the various example embodiments with reference to the accompanying drawings, like reference numerals refer to like components, and any repeated description related thereto may not be provided.

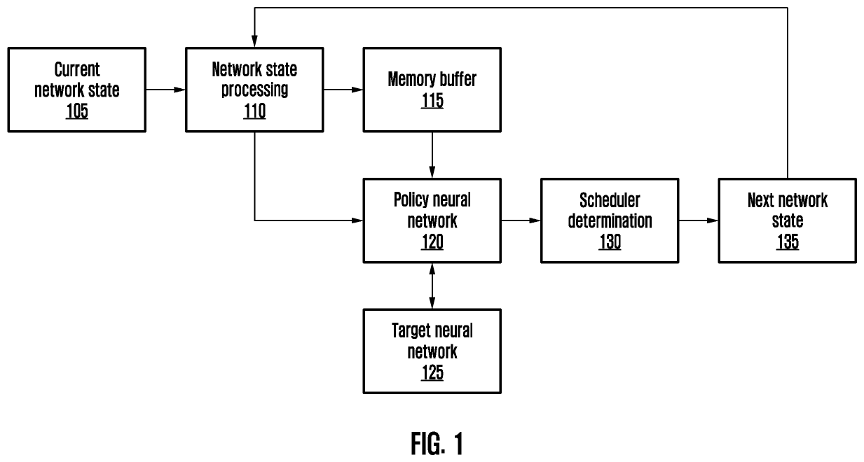

FIG. 1 is a diagram illustrating example operations performed by a scheduling device according to various embodiments.

A scheduler of a base station attempts scheduling by assigning time and frequency resources to a specific number of user equipments (UEs) included in a cell. Various types of schedulers may be used for scheduling. Since the time and frequency resources that can be assigned to UEs are limited, the quality of service (QOS) of a network for each UE may depend on the type of scheduler used for scheduling.

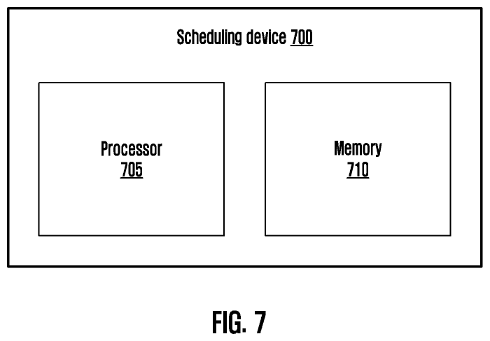

A scheduling device (e.g., a scheduling device 700 of FIG. 7) and method according to an embodiment may select a scheduler to be used for scheduling by reflecting the QoS of each of the UEs in real time when scheduling for a network using neural network-based reinforcement learning. The scheduling device and method according to an embodiment may track the QoS of the network at each transmission time interval (TTI) of a data packet and select a new scheduler to improve the QoS.

Referring to FIG. 1, a process of selecting a scheduler by the scheduling device based on the current network state is shown.

The scheduling device may select a scheduler based on a network state 105 of the current TTI (hereinafter, the “current network state”), and a network state 135 of the next TTI (hereinafter, the “next network state”) may be determined by the selected scheduler. In an embodiment, the scheduling device may select one of the various types of schedulers. For example, the scheduling device may select one of the various types of schedulers, such as a maximum throughput (MT) scheduler for maximizing/increasing the throughput of the entire network, a blind equal throughput (BET) scheduler for providing the equal throughput to all UEs, and a proportional fair (PF) scheduler for aiming at a balance between throughput and fairness.

The scheduling device may track the state of the network that changes at each TTI and analyze the state of the network, in a network state processing operation.

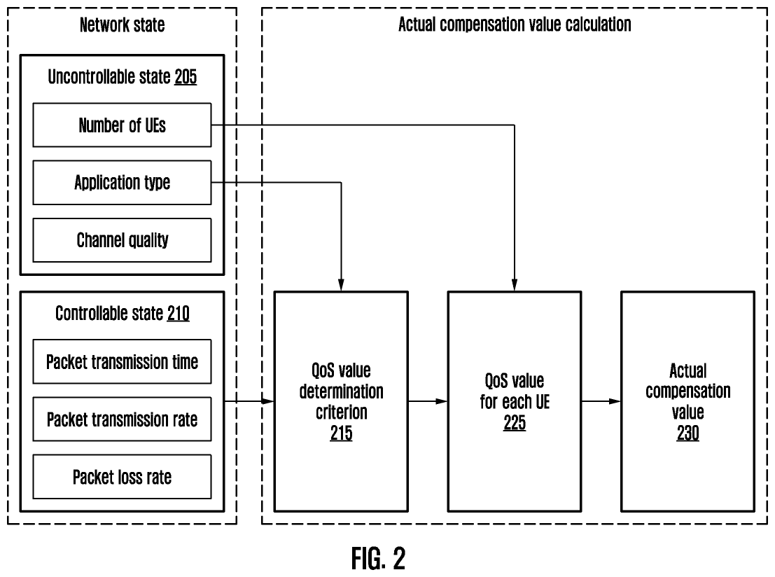

The scheduling device may divide the network state (e.g., the current network state 105 and the next network state 135) as a controllable state or an uncontrollable state, in operation 110. The controllable state may be a state that changes as the scheduler used for scheduling is changed, and may include a packet transmission time (packet delay), a packet transmission rate (or also “throughput”), and a packet loss rate (PLR). The uncontrollable state may be a state that changes irrespective of the scheduler used for scheduling, and may include the number of UEs, the type of application executed on a UE, and a channel state. In an embodiment, the controllable state may be used to calculate an actual compensation value for training a policy neural network 120. Operation 110 will be described further below with reference to FIG. 2.

The scheduling device may perform operation 130 of selecting a scheduler at each TTI. The scheduling device may be set in one of an exploration mode for training a policy neural network and an exploitation mode for selecting a scheduler using a trained policy neural network, and a scheduler may be selected differently according to the operating mode of the scheduling device.

In the exploration mode, the scheduling device may select any scheduler from among the various types of schedulers. The next network state 135 may be determined by the selected scheduler.

In the exploitation mode, the scheduling device may select a scheduler capable of obtaining the maximum compensation value for the current network state 105.

The scheduling device may determine again the actual compensation value by scheduler selection, in operation 110. The actual compensation value may be determined based on the QoS values determined for the UEs belonging to the network.

The scheduling device may store, in a memory buffer 115 (e.g., a memory 700 of FIG. 7), a data array including the current network state, the scheduler type selected in the current network state 105, the next network state 135, and the actual compensation value by scheduler selection. The data stored in the memory buffer 115 may be transmitted to the policy neural network 120 and used to update the parameters of the policy neural network 120.

The policy neural network 120 may include an input layer, hidden layers, and an output layer. The hidden layers may be implemented using one of a linear function and a non-linear function. The parameters of the policy neural network 120 may be initialized to an arbitrary value.

In the exploration mode, the policy neural network 120 may receive the network state and the scheduler type and output an estimated compensation value that is predicted. A target neural network 125 may be set to have the same parameters as the policy neural network 120, and may output the maximum compensation value that is predicted when an optimal scheduler is selected for the network state at a TTI next to the corresponding TTI. The scheduling device may periodically adjust the parameters of the target neural network 125 to be the same as the parameters of the policy neural network 120, when training the policy neural network 120.

In the exploitation mode, the policy neural network 120 may receive only the network state of the current TTI, and the scheduling device may select a scheduler using the output from the policy neural network 120, in operation 130.

FIG. 2 is a diagram illustrating an example network state processing operation performed by a scheduling device according to various embodiments.

In an embodiment, a scheduling device may perform the network state processing operation 110 to divide a network state (e.g., the current network state 105 and the next network state 135) as a controllable state 210 or an uncontrollable state 205.

The controllable state 210 may be a state that changes as a scheduler used for scheduling is changed, and may include a packet transmission time, a packet transmission rate, and a PLR. The packet transmission time may refer to the time consumed for a data packet transmitted from a base station to reach a UE. The packet transmission rate may refer to the number of packets transmitted based on 1 second (1000 TTIs). The PLR may refer to the number of data packets that a UE fails to receive compared to the total number of data packets transmitted.

The scheduling device may determine, for all scheduled EUs, a QoS value 225 for each UE based on a determination criterion 215 to determine a QoS value. The determination criterion 215 may include the conditions for the controllable state 210. For example, the determination criterion 215 may include a condition for the packet transmission time, a condition for the packet transmission rate, and a condition for the PLR. The scheduling device may determine whether the condition for the packet transmission time, the condition for the packet transmission rate, and the condition for the PLR are satisfied, and determine the number of satisfied conditions to be the QoS value 225 of the corresponding UE. For example, in response to only the condition for the packet transmission time being satisfied, the QoS value may be determined to be “⅓”, in response to the condition for the packet transmission time and the condition for the packet transmission rate being satisfied, the QoS value may be determined to be “⅔”, and in response to the condition for the packet transmission time, the condition for the packet transmission rate, and the condition for the PLR being all satisfied, the QoS value may be determined to be “1”. However, the foregoing is merely an example, and the determination criterion 215 for determining the QoS value and the QoS value 225 may be determined in various manners, as necessary.

In an embodiment, the determination criterion 215 for determining the QoS value may depend on the type of application executed on the terminal.

The scheduling device may calculate, for each TTI, an actual compensation value 230 to be used to train the policy neural network by calculating the average value of the QoS values of all the terminals at the current TTI.

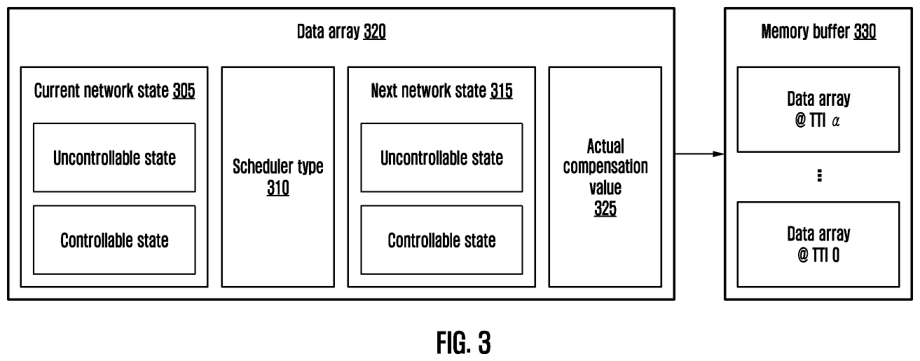

FIG. 3 is a diagram illustrating an example data array stored in a memory buffer of a scheduling device according to various embodiments.

Referring to FIG. 3, items of data included in a data array and data arrays stored in a memory buffer are shown.

A scheduling device may store, in a memory buffer 330 (e.g., the memory buffer 115 of FIG. 1), a data array including a current network state 305 (e.g., the current network state 105 of FIG. 1), a scheduler type 310 selected by the current network state 305, a next network state 315 (e.g., the next network state 135 of FIG. 1), and an actual compensation value 325 by scheduler selection. The current network state 305 and the next network state 315 may be divided as an uncontrollable state and a controllable state by the network state processing operation 110 of FIG. 1 and included in the data array.

The scheduling device may store, in the memory buffer 330, a data array 320 at each TTI until a set TTI elapses, in an exploration mode. The data arrays stored in the memory buffer 330 may be used to update the parameters of a policy neural network.

In response to the storage space of the memory buffer being full, the scheduling device may delete the data arrays from the oldest one and store a new data array. The size of the memory buffer may be set in various manners, as necessary.

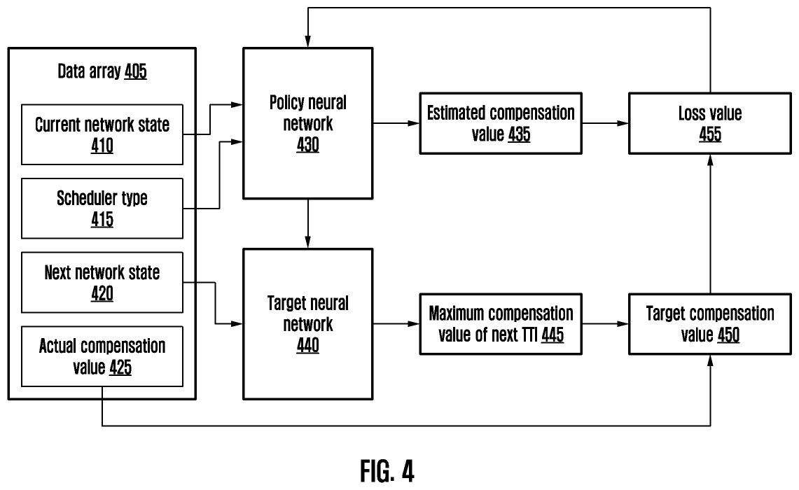

FIG. 4 is a diagram illustrating an example method of updating parameters of a policy neural network according to various embodiments.

In an exploration mode, a scheduling device may extract at least one data array 405 from a memory buffer. The number of data arrays 405 extracted may be determined based on a batch size. A batch may refer to a bundle of multiple data used to update the parameters of a policy neural network 430 once. The batch size may be set in various manners, as necessary.

The scheduling device may input a current network state 410 and a scheduler type 415 of the extracted data array 405 into the policy neural network 430. The policy neural network 430 may perform a neural network operation and output an estimated compensation value 435. The estimated compensation value 435 may be a compensation value predicted by the selection of a scheduler for the current network state 410.

The scheduling device may input a next network state 420 into a target neural network 440. The target neural network 440 may perform a neural network operation and output a maximum compensation value 445 of a next TTI. The maximum compensation value 445 may be a compensation value predicted when an optimal scheduler is selected in the next network state.

The scheduling device may determine a target compensation value 450 based on the maximum compensation value 445 and an actual compensation value 425 of the data array 405. The scheduling device may apply a set depreciation rate to the maximum compensation value 445, and determine the target compensation value 450 by adding the actual compensation value 425 and the compensation value to which the depreciation rate is applied. For example, the scheduling device may determine the target compensation value 450 using a Bellman equation.

The scheduling device may determine the difference between the target compensation value 450 and the estimated compensation value 435 to be a loss value 455. The scheduling device may adjust the parameters of the policy neural network 430 so that the loss value 455 may be decreased. The scheduling device may adjust the parameters of the policy neural network 430 at each TTI in which training is performed. The scheduling device may periodically update the parameters of the target neural network 440 to be the same as the parameters of the policy neural network 430 when training is performed.

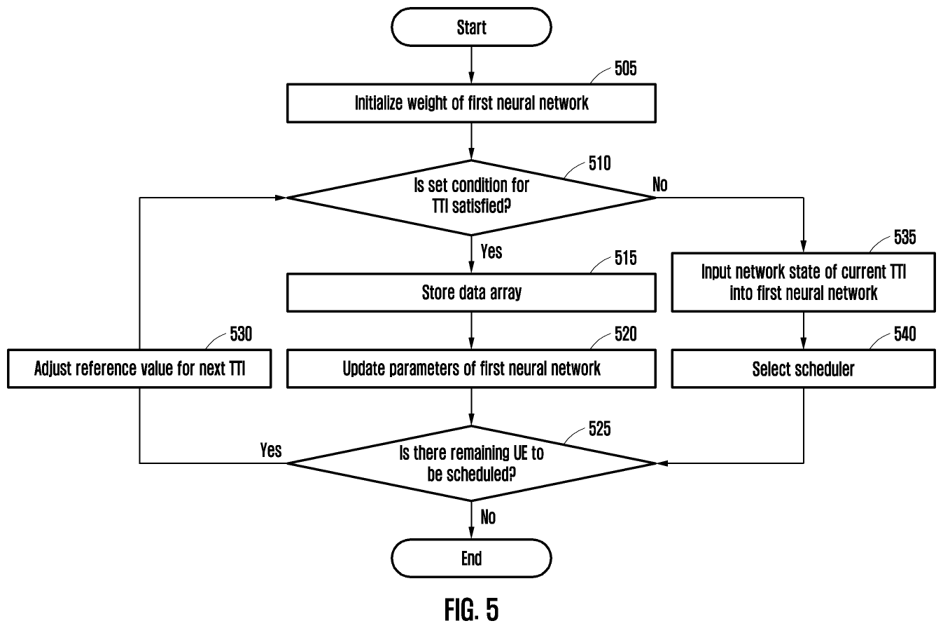

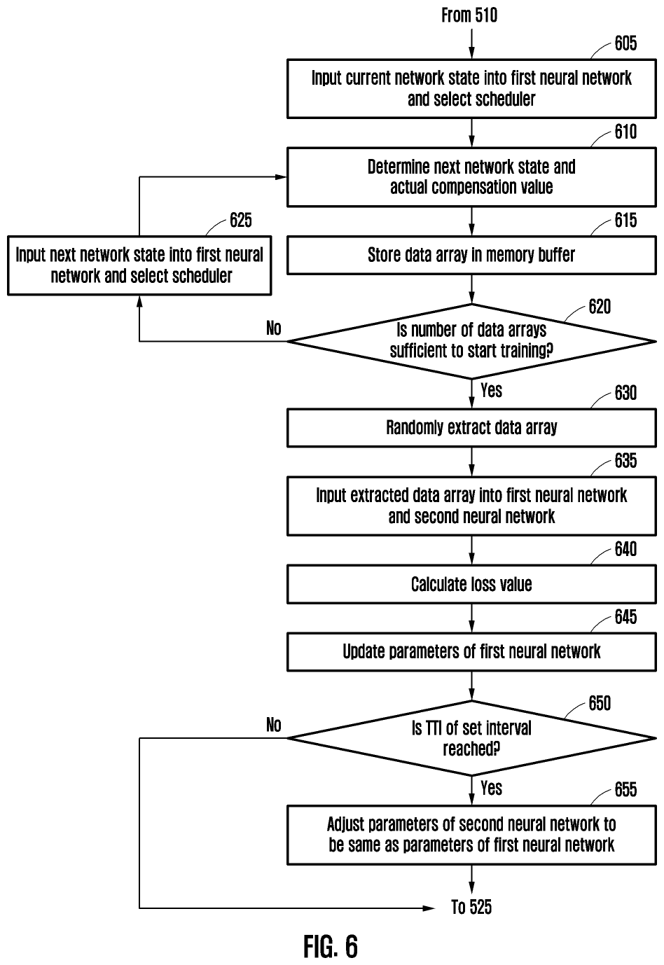

FIGS. 5 and 6 are flowcharts illustrating an example scheduling method according to various embodiments.

In operation 505, a scheduling device may initialize the parameters (e.g., weight) of a first neural network (e.g., the policy neural network 120 of FIG. 1). The scheduling device may further initialize the parameters of a second neural network (e.g., the target neural network 125 of FIG. 1).

In operation 510, the scheduling device may determine whether a set condition for a TTI is satisfied. In an embodiment, the set condition may be a condition set based on an epsilon-greedy algorithm. For example, the scheduling device may determine a reference value for the current TTI within a set value range. The scheduling device may compare the reference value with an arbitrary value determined within the set value range, and determine whether the set condition is satisfied according to the comparison result.

In an embodiment, the scheduling device may change the reference value so that the probability that the set condition will not be satisfied may increase as the TTI elapses. For example, the scheduling device may determine that the set condition is satisfied, in response to the reference value being greater than an arbitrary comparative value determined within the set value range (e.g., the value range between “0” and “1”). The scheduling device may determine that the set condition is not satisfied, in response to the reference value being less than the arbitrary comparative value determined within the set value range. The scheduling device may change the reference value to a smaller value by applying a set reduction rate to the reference value as time elapses.

In response to the set condition being satisfied in operation 510, the scheduling device may operate in an exploration mode, and in response to the set condition being not satisfied, the scheduling device may operate in an exploitation mode.

For example, in response to the set condition being satisfied, in operation 515, the scheduling device may store, in a memory buffer, a data array including a network state of the current TTI, a scheduler type selected in the network state of the current TTI, a network state of a next TTI, and an actual compensation value for the network state of the current TTI, at every TTI until a set TTI elapses. In an embodiment, the scheduling device may store the data array in the memory until the memory buffer is full.

In operation 520, the scheduling device may update the parameters of the first neural network based on at least one of the data arrays stored in the memory buffer.

In operation 525, the scheduling device may determine whether there is a remaining UE to be scheduled. In response to there being a remaining UE to be scheduled, the scheduling device may adjust the reference value for the next TTI, in operation 530. For example, the scheduling device may adjust the reference value by applying the set reduction rate to the reference value. In response to the reference value being adjusted, the scheduling device may perform operation 510 again at the next TTI.

In response to the set condition being not satisfied again in operation 510 of the current TTI, the scheduling device may input the network state of the current TTI into the first neural network, in operation 535. The scheduling device may select a scheduler using the output from the first neural network, in operation 540.

Hereinafter, a scheduling method in an exploration mode will be described in further detail with reference to FIG. 6.

In response to the set condition being satisfied in operation 510, the scheduling device may input the current network state into the first neural network and select a scheduler based on the output from the first neural network, in operation 605.

In operation 610, the scheduling device may determine the next network state and the actual compensation value based on the current network state and the selected scheduler. For example, the scheduling device may determine the next network state using the scheduler selected in the current network state. The scheduling device may determine the actual compensation value based on the current network state, as described with reference to FIG. 2.

In operation 615, the scheduling device may store, in the memory buffer, the data array including the current network state, the selected scheduler, the next network state, and the actual compensation value.

In operation 620, the scheduling device may determine whether the number of data arrays stored in the memory buffer is sufficient to start training the first neural network. In response to the number of data arrays stored in the memory buffer being insufficient, the scheduling device may input the next network state into the first neural network and select the scheduler, in operation 625. The scheduling device may repeat operations 610, 615, 620, and 625 until a sufficient number of data arrays are stored in the memory buffer.

For example, the scheduling device may repeat operations 610, 615, 620, and 625 until a set TTI elapses. In another example, the scheduling device may repeat operations 610, 615, 620, and 625 until the memory buffer is full.

In response to the number of data arrays stored in the memory buffer being sufficient, the scheduling device may randomly extract at least one data array from the memory buffer, in operation 630.

In operation 635, the scheduling device may input the extracted data array into the first neural network and the second neural network. For example, as described with reference to FIG. 4, the scheduling device may input the current network state and the scheduler type of the extracted data array into the first neural network, and input the next network state of the extracted data array into the second neural network.

In operation 640, the scheduling device may determine a loss value based on the output from the first neural network, the output from the second neural network, and the actual compensation value of the data array. For example, as described with reference to FIG. 4, the scheduling device may apply a depreciation rate to the maximum compensation value as the output from the second neural network, and determine a target compensation value by adding the actual compensation value and the maximum compensation value to which the depreciation rate is applied. The scheduling device may determine the loss value based on the difference between the estimated compensation value as the output from the first neural network and the target compensation value.

In operation 645, the scheduling device may update the parameters of the first neural network so that the loss value may decrease.

In operation 650 and operation 655, the scheduling device may periodically update the parameters of the second neural network to be the same as the parameters of the first neural network. For example, the scheduling device may determine whether a TTI of a set interval is reached, in operation 650, and adjust the parameters of the second neural network to be the same as the parameters of the first neural network in response to the set TTI being reached, in operation 655.

In an embodiment, operations 605, 610, 615, 620, and 625 may be included in operation 515 of FIG. 5, and operations 630, 635, 640, 645, 650, and 655 may be included in operation 520 of FIG. 5.

FIG. 7 is a block diagram illustrating an example configuration of a scheduling device according to various embodiments.

Referring to FIG. 7, the scheduling device 700 may include a processor (e.g., including processing circuitry) 705 and a memory configured to store instructions to be executed by the processor 705. The operations of FIGS. 5 and 6 may be performed by the processor 705.

In an embodiment, the memory buffer of FIGS. 1 to 6 may correspond to the memory 710 or may be included in the memory 710. In an embodiment, the scheduling device 700 may further include a memory buffer different from the memory 710.

The processor 705 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

When the instructions are executed by the processor 705, the processor 705 may perform determining whether a set condition for a TTI is satisfied, storing, in the memory 710 at each TTI until a set TTI elapses, a data array including a network state of a current TTI, a scheduler type selected at the network state of the current TTI, a network state of a next TTI, and an actual compensation value for the network state of the current TTI, in response to the set condition being satisfied, updating parameters of a first neural network based on at least one of data arrays stored in the memory 710, inputting the network state of the current TTI into the first neural network, in response to the set condition being not satisfied, and selecting a scheduler using an output from the first neural network based on the inputted network state of the current TTI.

The updating of the parameters may further include extracting at least one data array from the memory 710, and adjusting the parameters of the first neural network based on the extracted data array.

The extracting of the data array may include randomly extracting a number of data arrays corresponding to a set batch size from the memory 710.

The adjusting of the parameters of the first neural network may include determining an estimated compensation value by inputting the network state of the current TTI and the selected scheduler type included in the extracted data array into the first neural network, determining a maximum compensation value by inputting the network state of the next TTI included in the extracted data array into a second neural network, determining a target compensation value based on the maximum compensation value and the actual compensation value included in the extracted data array, determining a loss value based on a difference between the estimated compensation value and the target compensation value, and adjusting the parameters of the first neural network so that the loss value may decrease.

The determining of the target compensation value may include applying a set depreciation rate to the maximum compensation value, and determining the target compensation value by adding the actual compensation value and the maximum compensation value to which the depreciation rate is applied.

The updating of the parameters of the first neural network may include periodically updating parameters of the second neural network to be the same as the parameters of the first neural network.

The network state may include uncontrollable states regarding a number of communication UEs, a type of application, and a channel quality, and controllable states regarding a packet transmission time, a packet transmission rate, and a PLR.

The actual compensation value may be an average value of QoS values determined for communication UEs belonging to the network based on requirements regarding the type of application and the controllable states.

The determining of whether the set condition is satisfied may include determining a reference value for the current TTI within a set value range, and determining that the set condition is satisfied, in response to the reference value being greater than an arbitrary comparative value determined within the set value range.

The reference value may decrease as time elapses.

A scheduling method according to an example embodiment may include determining whether a set condition for a transmission time interval (TTI) is satisfied, storing, in a memory at each TTI until a set TTI elapses, a data array including a network state of a current TTI, a scheduler type selected at the network state of the current TTI, a network state of a next TTI, and an actual compensation value for the network state of the current TTI, in response to the set condition being satisfied, updating parameters of a first neural network based on at least one of data arrays stored in the memory, inputting the network state of the current TTI into the first neural network, in response to the set condition being not satisfied, and selecting a scheduler using an output from the first neural network based on the input network state of the current TTI.

The updating of the parameters may further include extracting at least one data array from the memory, and adjusting the parameters of the first neural network based on the extracted data array.

The extracting of the data array may include randomly extracting a number of data arrays corresponding to a set batch size from the memory.

The adjusting of the parameters of the first neural network may include determining an estimated compensation value by inputting the network state of the current TTI and the selected scheduler type included in the extracted data array into the first neural network, determining a maximum compensation value by inputting the network state of the next TTI included in the extracted data array into a second neural network, determining a target compensation value based on the maximum compensation value and the actual compensation value included in the extracted data array, determining a loss value based on a difference between the estimated compensation value and the target compensation value, and adjusting the parameters of the first neural network so that the loss value may decrease.

The determining of the target compensation value may include applying a set depreciation rate to the maximum compensation value, and determining the target compensation value by adding the actual compensation value and the maximum compensation value to which the depreciation rate is applied.

The updating of the parameters of the first neural network may include periodically updating parameters of the second neural network to be the same as the parameters of the first neural network.

The network state may include uncontrollable states regarding a number of communication UEs, a type of application, and a channel quality, and controllable states regarding a packet transmission time, a packet transmission rate, and a packet loss rate (PLR).

The actual compensation value may be an average value of quality of service (QOS) values determined for communication UEs belonging to the network based on requirements regarding the type of application and the controllable states.

The determining of whether the set condition is satisfied may include determining a reference value for the current TTI within a set value range, and determining that the set condition is satisfied, in response to the reference value being greater than an arbitrary comparative value determined within the set value range.

The network scheduling device and method according to various example embodiments may select a scheduler using artificial network network-based reinforcement learning, improving the QoS of a network.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1, A scheduling device for a network, the scheduling device comprising:
at least one processor, comprising processing circuitry; and
a memory configured to store instructions to be executed by at least one processor, wherein
at least one processor, individually and/or collectively is configured to execute the instructions and to cause the scheduling device to:
determine whether a set condition for a transmission time interval (TTI) is satisfied;
store, in the memory at each TTI until a set TTI elapses, a data array comprising a network state of a current TTI, a scheduler type selected at the network state of the current TTI, a network state of a next TTI, and an actual compensation value for the network state of the current TTI, in response to the set condition being satisfied;
update parameters of a first neural network based on at least one of data arrays stored in the memory;
input the network state of the current TTI into the first neural network, in response to the set condition being not satisfied; and
selecting a scheduler using an output from the first neural network based on the input network state of the current TTI.

2. The scheduling device of claim 1, wherein
the updating of the parameters further comprises:
extracting at least one data array from the memory; and
adjusting the parameters of the first neural network based on the extracted data array.

3. The scheduling device of claim 2, wherein
the extracting of the data array comprises randomly extracting a number of data arrays corresponding to a set batch size from the memory.

4. The scheduling device of claim 2, wherein
the adjusting of the parameters of the first neural network comprises:
determining an estimated compensation value by inputting the network state of the current TTI and the selected scheduler type included in the extracted data array into the first neural network;
determining a maximum compensation value by inputting the network state of the next TTI included in the extracted data array into a second neural network;
determining a target compensation value based on the maximum compensation value and the actual compensation value included in the extracted data array;
determining a loss value based on a difference between the estimated compensation value and the target compensation value; and
adjusting the parameters of the first neural network so that the loss value decreases.

5. The scheduling device of claim 4, wherein
the determining of the target compensation value comprises:
applying a set depreciation rate to the maximum compensation value; and
determining the target compensation value by adding the actual compensation value and the maximum compensation value to which the depreciation rate is applied.

6. The scheduling device of claim 4, wherein
the updating of the parameters of the first neural network comprises periodically updating parameters of the second neural network to be the same as the parameters of the first neural network.

7. The scheduling device of claim 1, wherein
the network state comprises:
uncontrollable states regarding a number of communication user equipments (UEs), a type of application, and a channel quality; and
controllable states regarding a packet transmission time, a packet transmission rate, and a packet loss rate, wherein
the actual compensation value is an average value of quality of service (QOS) values determined for communication UEs of the network based on requirements regarding the type of application and the controllable states.

8. The scheduling device of claim 1, wherein
the determining of whether the set condition is satisfied comprises:
determining a reference value for the current TTI within a set value range; and
determining that the set condition is satisfied, in response to the reference value being greater than an arbitrary comparative value determined within the set value range.

9. The scheduling device of claim 8, wherein
the reference value decreases as time elapses.

10. A scheduling method for a network, the scheduling method comprising:
determining whether a set condition for a transmission time interval (TTI) is satisfied;
storing, in a memory at each TTI until a set TTI elapses, a data array comprising a network state of a current TTI, a scheduler type selected at the network state of the current TTI, a network state of a next TTI, and an actual compensation value for the network state of the current TTI, in response to the set condition being satisfied;
updating parameters of a first neural network based on at least one of data arrays stored in the memory;
inputting the network state of the current TTI into the first neural network, in response to the set condition being not satisfied; and
selecting a scheduler using an output from the first neural network based on the input network state of the current TTI.

11. The scheduling method of claim 10, wherein
the updating of the parameters further comprises:
extracting at least one data array from the memory; and
adjusting the parameters of the first neural network based on the extracted data array.

12. The scheduling method of claim 11, wherein
the adjusting of the parameters of the first neural network comprises:
determining an estimated compensation value by inputting the network state of the current TTI and the selected scheduler type included in the extracted data array into the first neural network;
determining a maximum compensation value by inputting the network state of the next TTI included in the extracted data array into a second neural network;
determining a target compensation value based on the maximum compensation value and the actual compensation value included in the extracted data array;
determining a loss value based on a difference between the estimated compensation value and the target compensation value; and
adjusting the parameters of the first neural network so that the loss value decreases.

13. The scheduling method of claim 12, wherein
the determining of the target compensation value comprises:
applying a set depreciation rate to the maximum compensation value; and
determining the target compensation value by adding the actual compensation value and the maximum compensation value to which the depreciation rate is applied.

14. The scheduling method of claim 12, wherein
the updating of the parameters of the first neural network comprises periodically updating parameters of the second neural network to be the same as the parameters of the first neural network.

15. A non-transitory computer-readable storage medium storing a computer program to perform the method of claim 10.
